(19) United States
(12) Patent Application Publication
(10) Pub. No.: US 2017/0276491 A1
(43) Pub. Date: Sep. 28, 2017

(54) TECHNOLOGIES FOR GUIDED NAVIGATION USING THE SECURE USER PLANE LOCATION PROTOCOL

(71) Applicant: Intel IP Corporation, Santa Clara, CA (US)

(72) Inventors: Ram Mohan Reddy Boggala, Bangalore (IN); Chakradhara Panati, Bangalore (IN)

(21) Appl. No.: 15/080,926

(22) Filed: Mar. 25, 2016

(51) Int. Cl. G01C 21/34; G01C 21/36; H04W 4/02

(52) U.S. Cl. CPC G01C 21/34; H04W 4/023; G01C 21/36

(57) ABSTRACT

Technologies for guided navigation include one or more mobile computing devices and one or more location servers. A requestor mobile computing device establishes a secure data connection with a location server and sends a location request to the location server via the secure data connection. The request identifies a target and includes a request for directions. The target may be a geographic location or a target mobile computing device. The location server determines a route from the requestor mobile computing device to the target. If the target is a target mobile computing device, the location server may perform a positioning procedure with the target mobile computing device. The location server sends a response to the requestor mobile computing device that is indicative of the route from the requestor mobile computing device to the target. The response may include an image indicative of the route. Other embodiments are described and claimed.

### BACKGROUND

Mapping and other location services are important applications for today's mobile devices. Navigation for large indoor areas such as shopping malls, warehouses, or airport terminals is one such application. Typical mobile devices such as smart phones may execute a mapping application to provide indoor navigation. Visiting different locations may require downloading different mapping data and/or mapping applications. Additionally, existing map applications can provide directions to a known location or other fixed targets.

The Open Mobile Alliance has approved several versions of a Secure User Plane Location (SUPL) protocol, which may be used to determine location data for mobile devices. In particular, a SUPL Enabled Terminal (SET) may communicate with one or more SUPL Location Platforms (SLPs) to determine the position of the SET or a different SET.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for immersive guided navigation;

FIG. 2 is a simplified block diagram of at least one embodiment of various environments that may be established by the system of FIG. 1;

FIG. 3 is a simplified flow diagram of at least one embodiment of a method for guided navigation that may be executed by a requestor mobile computing device of FIGS. 1 and 2;

FIG. 4 is a pseudocode diagram of a location request that may be generated by the requestor mobile computing device of FIGS. 1-3; and

FIG. 5 is a simplified flow diagram of at least one embodiment of a method for guided navigation that may be executed by a location server of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

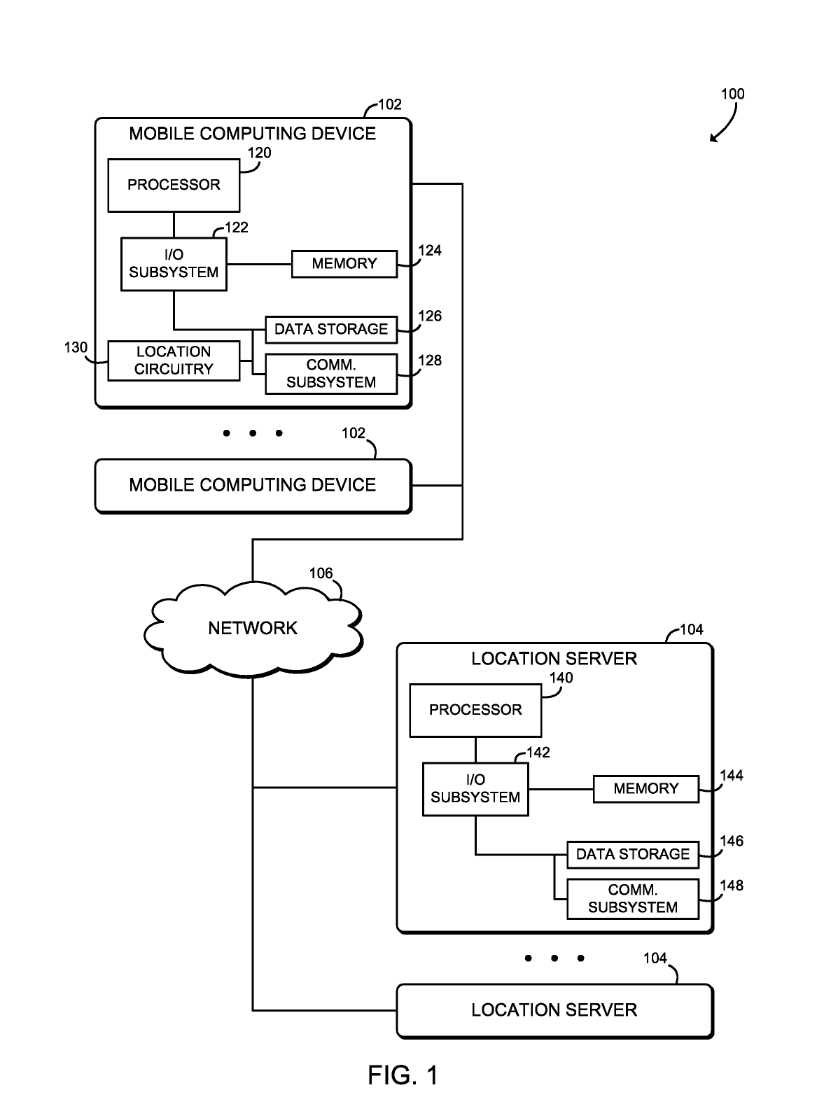

Referring now to FIG. 1, in an illustrative embodiment, a system 100 for guided navigation includes one or more mobile computing devices 102 and one or more location servers 104 in communication over a network 106. Each of the mobile computing devices 102 may perform the role of a Secure User Plane Location (SUPL) Enabled Terminal (SET), and each location server 104 may perform the role of a SUPL Location Platform (SLP). In use, as described in more detail below, a user of a mobile computing device 102a may generate a request for directions to a target destination, which may be a geographic location or the location of another mobile computing device 102b. For example, the user may request directions to a business or other target destination, or to the current location of a friend, which may be determined by the location of the friend's mobile computing device 102b. The mobile computing device 102a sends a secure user plane location (SUPL) protocol message to a location server 104 requesting the location of the target mobile computing device 102b. The request includes an indication that directions are needed. In response to the request, the location server 104 determines the location of the target. For example, the location server 104 may perform a positioning procedure (e.g., an assisted GPS positioning procedure) with the mobile computing device 102b. The location server 104 determines directions from the mobile computing device 102a to the target and then sends the directions to the mobile computing device 102a in a SUPL response message. In some embodiments, the requestor mobile computing device 102a may discover the location server 104, for example discovering a location server 104 dedicated to a specific area or indoor location.

Thus, the system 100 may provide dynamic directions, for example providing a user with directions to the current location of another user, which may change over time. Additionally, the system 100 may perform much of the map processing on the location server 104, which may reduce the hardware and/or software requirements of the mobile computing devices 102 (for example, by not requiring the mobile computing device 102 to execute or have installed a mapping application). Accordingly, the system 100 may provide directions to mobile computing devices 102 with limited computing resources, such as inexpensive mobile phones. Additionally, the system 100 may reduce the amount of mapping data that must be downloaded by each mobile computing device 102, which may reduce data charges and/or improve performance in low-connectivity areas (such as within large buildings).

Each mobile computing device 102 may be embodied as any type of computation or computer device capable of performing the functions described herein, including, without limitation, a mobile phone, a smart phone, a wearable computing device, a computer, a laptop computer, a notebook computer, a tablet computer, a network appliance, a web appliance, a distributed computing system, a processor-based system, and/or a consumer electronic device. As shown in FIG. 1, each mobile computing device 102 illustratively includes a processor 120, an input/output subsystem 122, a memory 124, a data storage device 126, and a communication subsystem 128. Of course, the mobile computing device 102 may include other or additional components, such as those commonly found in a smart phone (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the mobile computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the mobile computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processors 120, the memory 124, and other components of the mobile computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the mobile computing device 102 may be embodied as any communication circuit, device, or collection thereof, capable of enabling communications between the mobile computing device 102, the location server 104, and/or other remote devices over the network 106. The communication subsystem 128 may be configured to use any one or more communication technology (e.g., wired or wireless communications) and associated protocols (e.g., 3G, LTE, Ethernet, Bluetooth®, Wi-Fi®, WiMAX, etc.) to effect such communication.

As shown, each mobile computing device 102 may also include location circuitry 130. The location circuitry 130 of the mobile computing device 102 may be embodied as any type of circuit capable of determining the precise or approximate position of the mobile computing device 102. For example, the location circuitry 130 may be embodied as a global positioning system (GPS) receiver, capable of determining the precise coordinates of the mobile computing device 102. In other embodiments, the location circuitry 130 may triangulate or trilaterate the position of the mobile computing device 102 using distances or angles to cellular network towers or other radio beacons with known positions, which may be provided by the communication subsystem 128. In other embodiments, the location circuitry 130 may determine the approximate position of the mobile computing device 102 based on association to wireless networks with known positions, using the communication subsystem 128. In some embodiments, the location circuitry 130 may be capable of determining the location of the mobile computing device 102 using a local positioning system such as a system of beacons or other positioning devices installed in an indoor location.

Each mobile computing device 102 may also include any number of additional input/output devices, interface devices, and/or other peripheral devices. For example, in some embodiments, the peripheral devices may include a touch screen, graphics circuitry, keyboard, mouse, speaker system, network interface, and/or other input/output devices, interface devices, and/or peripheral devices.

Each location server 104 is configured to process location requests received from a mobile computing device 102 as described further herein. Each location server 104 may be embodied as any type of server computing device, or collection of devices, capable of performing the functions described herein including, without limitation, a computer, a multiprocessor system, a server, a rack-mounted server, a blade server, a network appliance, a distributed computing system, a processor-based system, and/or a consumer electronic device. As such, the location server 104 may be embodied as a single server computing device or a collection of servers and associated devices. For example, in some embodiments, the location server 104 may be embodied as a “virtual server” formed from multiple computing devices distributed across the network 106 and operating in a public or private cloud. Accordingly, although each location server 104 is illustrated in FIG. 1 and described below as embodied as a single server computing device, it should be appreciated that each location server 104 may be embodied as multiple devices cooperating together to facilitate the functionality described below. Illustratively, each location server 104 includes a processor 140, an I/O subsystem 142, a memory 144, a data storage device 146, a communication subsystem 148, and/or other components and devices commonly found in a server or similar computing device. Those individual components of the location server 104 may be similar to the corresponding components of the mobile computing device 102, the description of which is applicable to the corresponding components of the location server 104 and is not repeated herein so as not to obscure the present disclosure.

As discussed in more detail below, the mobile computing devices 102 and the location servers 104 may be configured to transmit and receive data with each other and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional base stations, computers, routers, and switches, to facilitate communications among the devices of the system 100.

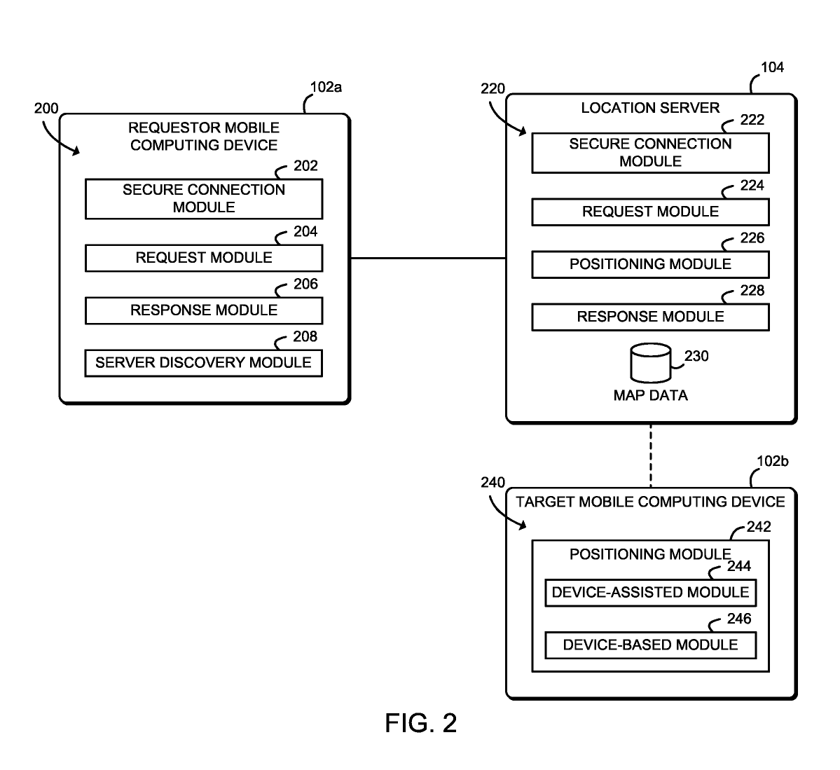

Referring now to FIG. 2, in an illustrative embodiment, a requestor mobile computing device 102a establishes an environment 200 during operation. The illustrative environment 200 includes a secure connection module 202, a request module 204, a response module 206, and a server discovery module 208. The various modules of the environment 200 may be embodied as hardware, firmware, software, or a combination thereof. As such, in some embodiments, one or more of the modules of the environment 200 may be embodied as circuitry or collection of electrical devices (e.g., secure connection circuitry 202, request circuitry 204, response circuitry 206, and/or server discovery circuitry 208). It should be appreciated that, in such embodiments, one or more of the secure connection circuitry 202, the request circuitry 204, the response circuitry 206, and/or the server discovery circuitry 208 may form a portion of one or more of the processor 120, the I/O subsystem 122, and/or other components of the requestor mobile computing device 102a. Additionally, in some embodiments, one or more of the illustrative modules may form a portion of another module and/or one or more of the illustrative modules may be independent of one another.

The secure connection module 202 is configured to establish a secure data connection with a location server 104. The secure data connection may be embodied as any secure communication channel with the location server 104 over the network 106. In the illustrative embodiment, the secure data connection is a secure TCP connection. In some embodiments, the requestor mobile computing device 102a may re-use an existing TCP connection to the location server 104.

The request module 204 is configured to send a location request to the location server 104 via the secure data connection. The location request includes an identifier of a target and a request for directions. The target may be embodied as a target geographic location (e.g., an address, a business name, geographic coordinates, or other geographic location) or a target mobile computing device 102b. In the illustrative embodiment, the location request is a secure user plane location (SUPL) protocol SUPL SET INIT message that includes a parameter indicative of the request for directions. In some embodiments, the location request may include a trigger parameter for periodic positioning.

The response module 206 is configured to receive a response from the location server 104 in response to sending the location request. The response is indicative of a route from the mobile computing device 102a to the target. In the illustrative embodiment, the response is a SUPL protocol SUPL END message that includes a parameter indicative of the route from the mobile computing device 102a to the target. The response may include, for example, geographic coordinates of the target, turn-by-turn directions to the target, directions to the target relative to a landmark, or an image indicative of the route from the mobile computing device 102a to the target. In some embodiments, the response module 206 may be configured to periodically receive a response from the location server 104. The response module 206 may be further configured to receive a message to stop periodic positioning from the location server 104. The message to stop periodic positioning may be indicative of a final route from the mobile computing device 102a to the target.

The server discovery module 208 is configured to discover the location server 104. The requestor mobile computing device 102a may use any network discovery protocol to discover the location server 104. For example, the mobile computing device 102a may discover a dedicated location server 104 associated with an indoor location. The secure connection module 202 may be configured to establish the secure data connection with the location server 104 in response to discovering the location server 104.

Still referring to FIG. 2, in the illustrative embodiment, the location server 104 establishes an environment 220 during operation. The illustrative environment 220 includes secure connection module 222, a request module 224, a positioning module 226, and a response module 228. The various modules of the environment 220 may be embodied as hardware, firmware, software, or a combination thereof. As such, in some embodiments, one or more of the modules of the environment 220 may be embodied as circuitry or collection of electrical devices (e.g., secure connection circuitry 222, request circuitry 224, positioning circuitry 226, and/or response circuitry 228). It should be appreciated that, in such embodiments, one or more of the secure connection circuitry 222, the request circuitry 224, the positioning circuitry 226, and/or the response circuitry 228 may form a portion of one or more of the processor 140, the I/O subsystem 142, and/or other components of the location server 104. Additionally, in some embodiments, one or more of the illustrative modules may form a portion of another module and/or one or more of the illustrative modules may be independent of one another.

The secure connection module 222 is configured to establish a secure data connection with the requestor mobile computing device 102a. As described above, the secure data connection may be embodied as any secure communication channel with the requestor mobile computing device 102a over the network 106. In the illustrative embodiment, the secure data connection is a secure TCP connection. In some embodiments, the location server 104 may re-use an existing TCP connection to the requestor mobile computing device 102a.

The request module 224 is configured to receive a location request from the requestor mobile computing device 102a via the secure data connection. The location request includes an identifier of a target and a request for directions. The target may be embodied as a target geographic location (e.g., an address, a business name, geographic coordinates, or other geographic location) or a target mobile computing device 102b. In the illustrative embodiment, the location request is a secure user plane location (SUPL) protocol SUPL SET INIT message that includes a parameter indicative of the request for directions. In some embodiments, the location request may include a trigger parameter for periodic positioning.

The positioning module 226 is configured to determine a route from the requestor mobile computing device 102a to the target based on a position of the target. The positioning module 226 may be configured to determine the route using map data 230. The map data 230 may be embodied as geographic data maintained by or otherwise accessible to the location server 104. The map data 230 may include information on locations of addresses, businesses, and other geographic locations as well as information on roads, hallways, or other routes to reach those geographic locations. In some embodiments, the map data 230 may be dedicated to a particular indoor location such as a shopping mall, warehouse, airport, or other large building. In some embodiments, the positioning module 226 may be configured to generate an image indicative of the route from the mobile computing device 102a to the target. The map data 230 may also include bitmap data, vector data, or other graphical data that may be used to generate map images. In some embodiments, when the target is a target mobile computing device 102b, the positioning module 226 may be further configured to perform a positioning procedure with the target mobile computing device 102b to determine the position of the target mobile computing device 102b. The positioning module 226 may be configured to perform, for example, a device-assisted positioning procedure or a device-based positioning procedure with the target mobile computing device 102b. In some embodiments, the positioning module 226 may be configured to determine the location of the target mobile computing device 102b using a local positioning system of an indoor location.

The response module 228 is configured to send a response to the requestor mobile computing device 102a. The response is indicative of the route from the requestor mobile computing device 102a to the target. In the illustrative embodiment, the response is a SUPL protocol SUPL END message that includes a parameter indicative of the route from the mobile computing device 102a to the target. The response may include, for example, geographic coordinates of the target, turn-by-turn directions to the target, directions to the target relative to a landmark, or an image indicative of the route from the mobile computing device 102a to the target. In some embodiments, the response module 228 may be configured to periodically send a response to the requestor mobile computing device 102a. The response module 228 may be further configured to send a message to stop periodic positioning to the requestor mobile computing device 102a. The message to stop periodic positioning may be indicative of a final route from the mobile computing device 102a to the target.

Still referring to FIG. 2, in the illustrative embodiment, a target mobile computing device 102b establishes an environment 240 during operation. The illustrative environment 240 includes a positioning module 242, which may be embodied as hardware, firmware, software, or a combination thereof. As such, in some embodiments, the positioning module 242 may be embodied as circuitry or collection of electrical devices (e.g., positioning circuitry 242). It should be appreciated that, in such embodiments, the positioning circuitry 242 may form a portion of one or more of the processor 120, the I/O subsystem 122, the location circuitry 130, and/or other components of the target mobile computing device 102b. Additionally, in some embodiments, one or more of the illustrative modules may form a portion of another module and/or one or more of the illustrative modules may be independent of one another.

The positioning module 242 is configured to perform a positioning procedure with the location server 104 to determine the position of the target mobile computing device 102b. The target mobile computing device 102b may be configured to perform, for example, a device-assisted positioning procedure or a device-based positioning procedure with the location server 104. In some embodiments, the positioning module 242 may be configured to determine the location of the target mobile computing device 102b using a local positioning system of an indoor location. In some embodiments, those functions may be performed by one or more sub-modules, such as a device-assisted module 244 or a device-based module 246.

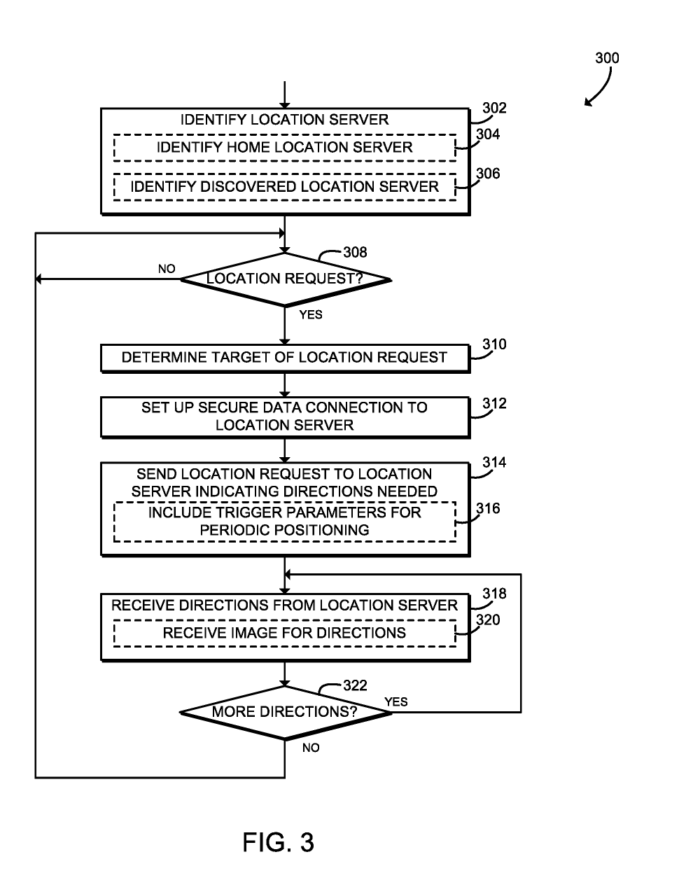

Referring now to FIG. 3, in use, the requestor mobile computing device 102a may execute a method 300 for guided navigation. It should be appreciated that, in some embodiments, the method 300 may be embodied as various instructions stored on a computer-readable media, which may be executed by the processor 120, the I/O subsystem 122, and/or other components of the requestor mobile computing device 102a to cause the requestor mobile computing device 102a to perform the method 300. The computer-readable media may be embodied as any type of media capable of being read by the requestor mobile computing device 102a including, but not limited to, the memory 124, the data storage device 126, other memory or data storage devices of the requestor mobile computing device 102a, portable media readable by a peripheral device of the requestor mobile computing device 102a, and/or other media.

The method 300 begins with block 302, in which the requestor mobile computing device 102a identifies a location server 104. The requestor mobile computing device 102a may identify a location server 104 that performs the role of a SUPL Location Platform (SLP). In particular, the requestor mobile computing device 102a may determine the domain name, address, or other identifier of a location server 104 that may provide directional information to the requestor mobile computing device 102a. In some embodiments, in block 304 the requestor mobile computing device 102a may identify a home location server 104. The fully qualified domain name of the home location server 104 may be provisioned to the requestor mobile computing device 102a by the home network of the requestor mobile computing device 102a. For example, the fully qualified domain name of the home location server 104 may be stored in a UICC, SIM card, or other secure storage of the requestor mobile computing device 102a. In some embodiments, the home location server 104 may be the H-SLP provisioned to the requestor computing device 102a.

In some embodiments, in block 306 the requestor mobile computing device 102a may identify a discovered location server 104. For example, the requestor mobile computing device 102a may identify a discovered location server 104 provided for the current indoor location, building, or other geographic location. The discovered location server 104 may be a D-SLP discovered by the requestor computing device 102a. The requestor mobile computing device 102a may use any network discovery protocol to identify the discovered location server 104. In particular, in some embodiments the requestor mobile computing device 102a may use an unsecure protocol and/or unsecure connection (e.g., the dynamic host configuration protocol (DHCP)) to discover the discovered location server 104. In some embodiments, the requestor mobile computing device 102a may request a location server 104 (e.g., the H-SLP provisioned to the requestor mobile computing device 102a) for a list of other location servers 104 available in the current area. In turn, the location server 104 may provide a list of location servers 104 to be used in order of priority (e.g., a list of D-SLPs). The location server 104 may also provide the validity of each discovered location server 104.

After identifying the location server 104, in block 308 the requestor mobile computing device 102a monitors for new location requests. The requestor mobile computing device 102a may receive location requests from a user, for example through a maps application or other user interface of the requestor mobile computing device 102a. If no location request is received, the method 300 loops back to block 308 to continue monitoring for location requests. If a location request is received, the method 300 advances to block 310.

In block 310, the requestor mobile computing device 102a determines the target of the location request. The target may be embodied as any destination for directions specified by the user of the requestor mobile computing device 102a. The target may be embodied as a name, address, search term, or other identifier of a physical location. For example, the target may specify the name of a business within a shopping mall, the number of a gate within an airport, keywords related to a particular product in a department store, or any other data that may be used to identify the target. Additionally or alternatively, the target may be embodied as a target mobile computing device 102b. For example, the target mobile computing device 102b may be associated with a name, phone number, International Mobile Subscriber Identity (IMSI), International Mobile Station Equipment Identifier (IMEI), or other user identifier supplied by the user.

In block 312, the requestor mobile computing device 102a sets up a secure data connection to the location server 104. The requestor mobile computing device 102a may communicate with the location server 104 over the network 106 using any available secure data connection. For example, the requestor mobile computing device 102a may communicate using a cellular networking connection (e.g., 3G or LTE) or a wireless networking connection (e.g., Wi-Fi). The requestor mobile computing device 102a may communicate with the location server 104 using any secure network protocol. In the illustrative embodiment, the requestor mobile computing device 102a communicates with the location server 104 over a secure TCP connection. In some embodiments, the requestor mobile computing device 102a may re-use an existing TCP connection to the location server 104. As described above in connection with block 306, in some embodiments the requestor mobile computing device 102a may establish the secure data connection after discovering the location server 104 using an unsecure network discovery protocol.

In block 314, the requestor mobile computing device 102a sends a request to the location server 104 indicating directions are needed. The request also identifies the target, which is the requested destination of the directions. In some embodiments, the request may include an identifier of the target mobile computing device 102b such as a network address, IMSI, or other identifier. For example, the identifier of the target mobile computing device 102b may be a SUPL SETId. In the illustrative embodiment, the request is embodied as a SUPL SET INIT message that includes an additional parameter set to indicate that directions are required (e.g., a parameter directionsNeeded that is set to true). Additionally or alternatively, in some embodiments the request may identify a geographic location as the target rather than the target mobile computing device 102b. In those embodiments, the request may include a name, address, search term, or other identifier of the physical location. In some embodiments, in block 316 the requestor mobile computing device 102a may include trigger parameters for periodic positioning in the request. The trigger parameters may include, for example, the frequency to determine positional fixes, the total number of positional fixes to determine, conditions to evaluate before determining a fix, or other parameters to specify how multiple positional fixes are to be determined.

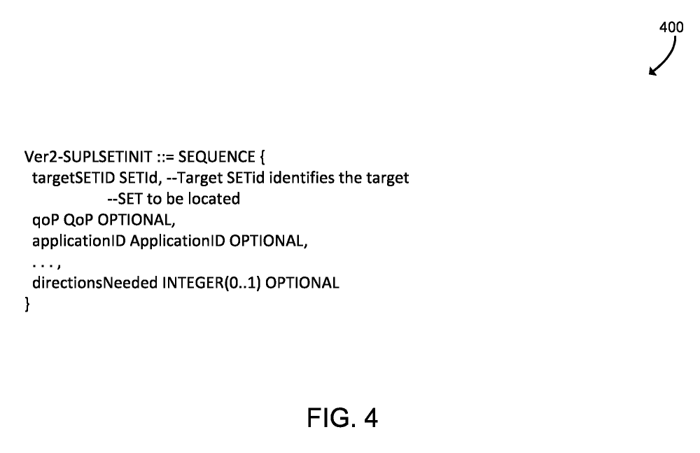

Referring now to FIG. 4, pseudocode 400 illustrates syntax for one potential embodiment of a location request that may be sent by the requestor mobile computing device 102a. As shown, the request may include an optional parameter directionsNeeded. When set to one, directionsNeeded indicates that directions are requested, and when set to zero, directionsNeeded indicates that directions are not requested.

Referring back to FIG. 3, in block 318, the requestor mobile computing device 102a receives directions from the location server 104. The directions may be embodied as any data indicative of the route from the requestor mobile computing device 102a to the target. For example, the directions may include geographic coordinates of the target, one or more turn-by-turn directions to the target (e.g., “ahead 10 kilometers, turn left,” etc.), directions to the target relative to one or more intermediate landmarks (e.g., natural features, businesses, or other well-known locations), or other data. The directions may be included as a parameter in a message from the location server 104. For example, in the illustrative embodiment, the directions are included in an optional Directions parameter included in a SUPL END message or a SUPL REPORT message (used when the location server 104 provides multiple position fixes). Because the directions are included in a message from the location server 104, the requestor mobile computing device 102a may not require access to the map data 230 to determine directions to the target.

In some embodiments, in block 320 the requestor mobile computing device 102a may receive an image for the directions. The image may correspond to a route map, birds-eye view, or other graphical representation of the directions. The image may also be included as an image file encoded in the message from the location server 104. For example, in the illustrative embodiment, the image is included in an optional Image-JP parameter of a a SUPL END message or a SUPL REPORT message (used when the location server 104 provides multiple position fixes). Because the image is included in the message from the location server 104, the requestor mobile computing device 102a may not be required to download large amounts of other map data 230 and/or other image data to display an image for the directions.

In block 322, the requestor mobile computing device 102a determines whether additional directions remain to be received. For example, when requesting periodic positioning, the requestor mobile computing device 102a may expect to receive a certain number of position fixes from the location server 104. In some embodiments, the requestor mobile computing device 102a may determine whether it has received a message from the location server 104 indicating that the positioning session is completed, such as a SUPL END message. If additional directions may be received, the method 300 loops back to block 318 to continue receiving directions from the location server 104. If the requestor mobile computing device 102a determines that no additional directions will be received, the method 300 loops back to block 308, in which the requestor mobile computing device 102a continues to monitor for location requests from the user. After receiving the directions, the requestor mobile computing device 102a may close the secure connection to the location server 104 and otherwise release resources used for the positioning session.

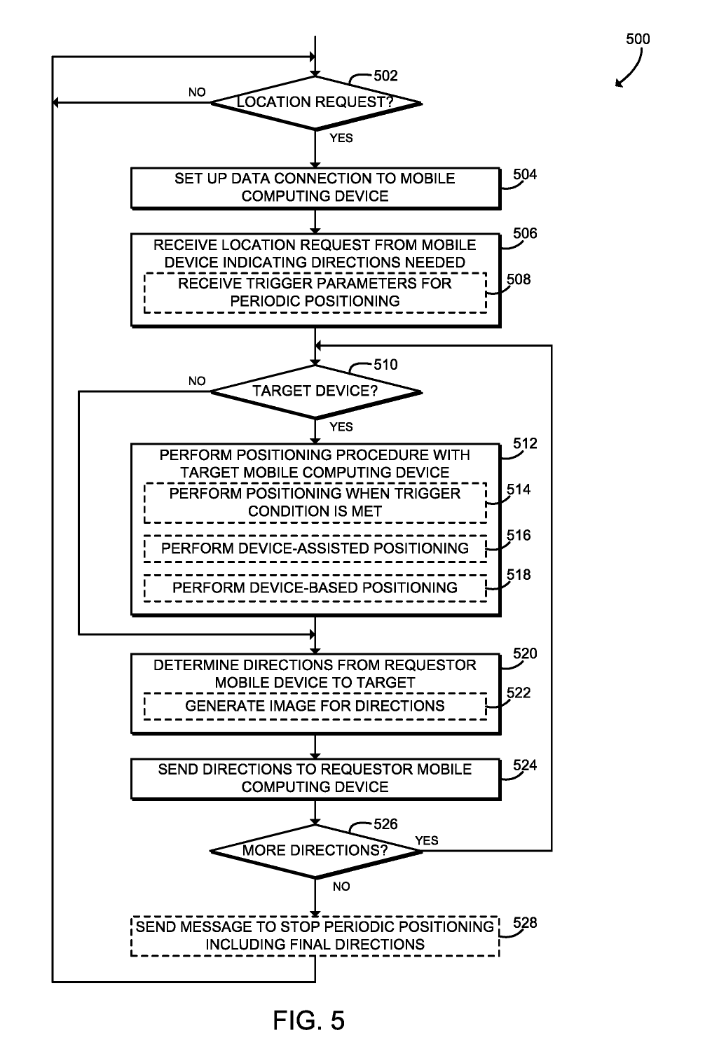

Referring now to FIG. 5, in use, the location server 104 may execute a method 500 for guided navigation. It should be appreciated that, in some embodiments, the method 500 may be embodied as various instructions stored on a computer-readable media, which may be executed by the processor 140, the I/O subsystem 142, and/or other components of the location server 104 to cause the location server 104 to perform the method 500. The computer-readable media may be embodied as any type of media capable of being read by the location server 104 including, but not limited to, the memory 144, the data storage device 146, other memory or data storage devices of the location server 104, portable media readable by a peripheral device of the location server 104, and/or other media.

The method 500 begins in block 502, in which the location server 104 determines whether a location request has been received from a requestor mobile computing device 102a. The location server 104 may, for example, monitor for network connection requests from one or more mobile computing devices 102. If no location request has been received, the method 500 loops back to block 502 to continue monitoring for location requests. If a location request has been received, the method 500 advances to block 504.

In block 504, the location server 104 sets up a secure data connection with the requestor mobile computing device 102a. As described above, the location server 104 may communicate with the requestor mobile computing device 102a using any secure network protocol. In the illustrative embodiment, the location server 104 communicates with the requestor mobile computing device 102a over a secure TCP connection. In some embodiments, the location server 104 may re-use an existing TCP connection to the requestor mobile computing device 102a.

In block 506, the location server 104 receives a request from the requestor mobile computing device 102a indicating directions are needed. The request also identifies the target, which is the requested destination of the directions. In some embodiments, the request may include an identifier of the target mobile computing device 102b such as a network address, IMSI, or other identifier. For example, the identifier of the target mobile computing device 102b may be a SUPL SETId. In the illustrative embodiment, the request is embodied as a SUPL SET INIT message that includes an additional parameter set to indicate that directions are required (e.g., a parameter directionsNeeded that is set to true). Additionally or alternatively, in some embodiments the request may identify a geographic location as the target rather than the target mobile computing device 102b. In those embodiments, the request may include a name, address, search term, or other identifier of the physical location. In some embodiments, in block 508 the location server 104 may receive trigger parameters for periodic positioning in the request. The trigger parameters may include, for example, the frequency to determine positional fixes, the total number of positional fixes to determine, conditions to evaluate before determining a fix, or other parameters to specify how multiple positional fixes are to be determined.

In block 510, the location server 104 determines whether the requested target is the location of a target mobile computing device 102b. For example, as described above, the request may include an identifier of the target mobile computing device 102b such as a network address, IMEI, IMSI, or other identifier. If the target is not a target mobile computing device 102b (e.g., the target is a geographic location), the method 500 branches ahead to block 520, described below. If the target is a target mobile computing device 102b, the method 500 advances to block 512.

In block 512, the location server 104 performs a positioning procedure with the target mobile computing device 102b to determine the position of the target mobile computing device 102b. The location server 104 may use any appropriate positioning procedure with the target mobile computing device 102b. For example, the location server 104 may send and/or receive SUPL POS messages with the target mobile computing device 102b that encapsulate the positioning procedure. In some embodiments, the location server 104 may also communicate with one or more other location servers 104 to perform the positioning procedure. For example, the location server 104 may communicate with an H-SLP and/or D-SLP associated with the target mobile computing device 102b. In some embodiments, the location server 104 and the target mobile computing device 102b may perform the positioning procedure using a local positioning system of an indoor location. For example, a location server 104 that is dedicated to an indoor location such as a shopping mall, warehouse, airport, or other large building may determine the location of the target mobile computing device 102b using a local positioning system installed in the indoor location.

In some embodiments, in block 514 the location server 104 may perform the positioning procedure when one or more trigger conditions is met. For example, the location server 104 may perform the positioning procedure after a specified time has elapsed or other condition has been satisfied. In some embodiments, in block 516 the location server 104 may perform a device-assisted positing procedure. In those embodiments, the location server 104 may determine the location of the target mobile computing device 102b. The determination of position may be based on additional information provided by the target mobile computing device 102b. In some embodiments, in block 518 the location server 104 may perform a device-based positioning procedure. In those embodiments, the target mobile computing device 102b may determine its own location, for example using its associated location circuitry 130. The target mobile computing device 102b may determine its location using additional information provided by the location server 104.

In block 520, the location server 104 determines directions from the requestor mobile computing device 102a to the target. For example, the location server 104 may determine directions to the location of the target mobile computing device 102b determined as described above in connection with block 512. Additionally or alternatively, the location server 104 may determine the location of the target using the map data 230, for example by searching for a specified name, address, or other geographic location. The location server 104 may use any appropriate pathfinding algorithm or other technique to determine the directions. In particular, the location server 104 may access the map data 230 to determine the directions. As described above, the directions may be embodied as any data indicative of the route from the requestor mobile computing device 102a to the target. For example, the directions may include geographic coordinates of the target, one or more turn-by-turn directions to the target (e.g., “ahead 10 kilometers, turn left,” etc.), directions to the target relative to one or more intermediate landmarks (e.g., natural features, businesses, or other well-known locations), or other data. In some embodiments, in block 522 the location server 104 may generate an image for the directions. The image may correspond to a route map, birds-eye view, turn-by-turn diagram, or other graphical representation of the directions. The image may be generated using the map data 230, for example by including a map image from the map data 230 or by rendering a map image based on the map data 230.

In block 524, the location server 104 sends the directions to the requestor mobile computing device 102a. The directions may be included as a parameter in a message sent to the requestor mobile computing device 102a. For example, in the illustrative embodiment, the directions are included in an optional Directions parameter included in a SUPL END message or a SUPL REPORT message (used when the location server 104 provides multiple position fixes). Similarly, the image for the directions (if any) may be included as an image file encoded in the message. For example, in the illustrative embodiment, the image may be included in an optional Image-JP parameter of a SUPL END message or a SUPL REPORT message (used when the location server 104 provides multiple position fixes).

In block 526, the location server 104 determines whether additional directions remain to be sent to the requestor mobile computing device 102a. For example, the location server 104 may determine whether the requestor mobile computing device 102a included trigger parameters in the request as described above in connection with block 508. The location server 104 may also determine, for example, whether the requested number of positioning fixes have been performed. If additional directions remain, the method 500 loops back to block 510 to continue providing directions. If no additional directions remain, the method 500 advances to block 528.

In block 528, in some embodiments, the location server 104 may send a message to stop periodic positioning to the requestor mobile computing device 102a. For example, after sending a series of SUPL REPORT messages, the location server 104 may send a SUPL END message to the requestor mobile computing device 102a. The SUPL END message may indicate that the periodic positioning session has been completed or otherwise stopped. Additionally or alternatively, in some embodiments the message may include final directions to the target mobile computing device 102b. The directions may be included as a parameter of the message as described above in connection with block 524. After sending the message, the method 500 loops back to block 502 to continue monitoring for location requests. If no message to stop periodic positioning is sent (e.g., if the requestor mobile computing device 102a requested a single fix), the method 500 may loop back to block 502 directly after sending the directions as described above in connection with block 524. After sending the directions to the requestor mobile computing device 102a, the location server 104 may close the secure connection to the requestor mobile computing device 102a and otherwise release resources used for the positioning session.

### EXAMPLES

Illustrative examples of the technologies disclosed herein are provided below. An embodiment of the technologies may include any one or more, and any combination of, the examples described below.

Example 1 includes a mobile computing device for guided navigation, the mobile computing device comprising: a secure connection module to establish a secure data connection with a location server; a request module to send a location request to the location server via the secure data connection, wherein the location request includes an identifier of a target and a request for directions; and a response module to receive a response from the location server in response to sending of the location request, wherein the response is indicative of a route from the mobile computing device to the target.

Example 2 includes the subject matter of Example 1, and wherein the location request includes an identifier indicative of the target, wherein the target comprises a target geographic location.

Example 3 includes the subject matter of any of Examples 1 and 2, and wherein the location request includes an identifier indicative of the target, wherein the target comprises a target mobile computing device.

Example 4 includes the subject matter of any of Examples 1-3, and wherein: the location request comprises a secure user plane location protocol message that includes a parameter indicative of the request for directions; and the response comprises a secure user plane location protocol message that includes a parameter indicative of the route from the mobile computing device to the target.

Example 5 includes the subject matter of any of Examples 1-4, and wherein: the location request comprises a secure user plane location protocol SUPL SET INIT message, wherein the SUPL SET INIT message includes the parameter indicative of the request for directions; and the response comprises a secure user plane location protocol SUPL END message, wherein the SUPL END message includes the parameter indicative of the route from the mobile computing device to the target.

Example 6 includes the subject matter of any of Examples 1-5, and further comprising a server discovery module to discover the location server; wherein to establish the secure data connection with the location server comprises to establish the secure data connection in response to discovery of the location server.

Example 7 includes the subject matter of any of Examples 1-6, and wherein to establish the secure data connection with the location server comprises to establish the secure data connection in response to discovery of the location server via an unsecure network discovery protocol.

Example 8 includes the subject matter of any of Examples 1-7, and wherein the response includes geographic coordinates of the target.

Example 9 includes the subject matter of any of Examples 1-8, and wherein the response includes turn-by-turn directions to the target.

Example 10 includes the subject matter of any of Examples 1-9, and wherein the response includes directions to the target relative to a landmark.

Example 11 includes the subject matter of any of Examples 1-10, and wherein the response includes an image indicative of the route from the mobile computing device to the target.

Example 12 includes the subject matter of any of Examples 1-11, and wherein: the location request includes a trigger parameter for periodic positioning; and to receive the response from the location server in response to the sending of the location request comprises to periodically receive a response from the location server in response to the sending of the location request.

Example 13 includes the subject matter of any of Examples 1-12, and wherein the response module is further to receive a message to stop periodic positioning from the location server in response to the sending of the location request, wherein the message is indicative of a final route from the mobile computing device to the target.

Example 14 includes the subject matter of any of Examples 1-13, and wherein: the location request comprises a secure user plane location protocol SUPL SET INIT message, wherein the SUPL SET INIT message includes a parameter indicative of the request for directions; and the response comprises a secure user plane location protocol SUPL REPORT message, wherein the SUPL REPORT message includes a parameter indicative of the route from the mobile computing device to the target.

Example 15 includes a computing device for guided navigation, the computing device comprising: a secure connection module to establish a secure data connection with a requestor mobile computing device; a request module to receive a location request from the requestor mobile computing device via the secure data connection, wherein the location request includes an identifier of a target and a request for directions; a positioning module to determine a route from the requestor mobile computing device to the target based on a position of the target; and a response module to send a response to the requestor mobile computing device, wherein the response is indicative of the route from the requestor mobile computing device to the target.

Example 16 includes the subject matter of Example 15, and wherein the location request includes an identifier indicative of the target, wherein the target comprises a target geographic location.

Example 17 includes the subject matter of any of Examples 15 and 16, and wherein the location request includes an identifier indicative of the target, wherein the target comprises a target mobile computing device.

Example 18 includes the subject matter of any of Examples 15-17, and wherein the positioning module is further to perform, in response to receipt of the location request, a positioning procedure with the target mobile computing device to determine the position of the target mobile computing device.

Example 19 includes the subject matter of any of Examples 15-18, and wherein to perform the positioning procedure with the target mobile computing device comprises to perform a device-assisted positioning procedure with the target mobile computing device.

Example 20 includes the subject matter of any of Examples 15-19, and wherein to perform the positioning procedure with the target mobile computing device comprises to perform a device-based positioning procedure with the target mobile computing device.

Example 21 includes the subject matter of any of Examples 15-20, and wherein to perform the positioning procedure comprises to perform the positioning procedure with a local positioning system.

Example 22 includes the subject matter of any of Examples 15-21, and wherein: the location request comprises a secure user plane location protocol message that includes a parameter indicative of the request for directions; and the response comprises a secure user plane location protocol message that includes a parameter indicative of the route from the mobile computing device to the target.

Example 23 includes the subject matter of any of Examples 15-22, and wherein: the location request comprises a secure user plane location protocol SUPL SET INIT message, wherein the SUPL SET INIT message includes the parameter indicative of the request for directions; and the response comprises a secure user plane location protocol SUPL END message, wherein the SUPL END message includes the parameter indicative of the route from the mobile computing device to the target.

Example 24 includes the subject matter of any of Examples 15-23, and wherein the response includes geographic coordinates of the target.

Example 25 includes the subject matter of any of Examples 15-24, and wherein the response includes turn-by-turn directions to the target.

Example 26 includes the subject matter of any of Examples 15-25, and wherein the response includes directions to the target relative to a landmark.

Example 27 includes the subject matter of any of Examples 15-26, and wherein: to determine the route from the requestor mobile computing device to the target comprises to generate an image indicative of the route from the mobile computing device to the target; and to send the response to the requestor mobile computing device comprises to send a response that includes the image.

Example 28 includes the subject matter of any of Examples 15-27, and wherein: the location request includes a trigger parameter for periodic positioning; and to send the response to the requestor mobile computing device comprises to periodically send a response to the requestor mobile computing device in response to receipt of the location request.

Example 29 includes the subject matter of any of Examples 15-28, and wherein the response module is further to send a message to stop periodic positioning to the requestor mobile computing device in response to receipt of the location request, wherein the message is indicative of a final route from the requestor mobile computing device to the target.

Example 30 includes the subject matter of any of Examples 15-29, and wherein: the location request comprises a secure user plane location protocol SUPL SET INIT message, wherein the SUPL SET INIT message includes a parameter indicative of the request for directions; and the response comprises a secure user plane location protocol SUPL REPORT message, wherein the SUPL REPORT message includes a parameter indicative of the route from the requestor mobile computing device to the target.

Example 31 includes a method for guided navigation, the method comprising: establishing, by a mobile computing device, a secure data connection with a location server; sending, by the mobile computing device, a location request to the location server via the secure data connection, wherein the location request includes an identifier of a target and a request for directions; and receiving, by the mobile computing device, a response from the location server in response to sending the location request, wherein the response is indicative of a route from the mobile computing device to the target.

Example 32 includes the subject matter of Example 31, and wherein sending the location request comprises sending a location request that includes an identifier indicative of the target, wherein the target comprises a target geographic location.

Example 33 includes the subject matter of any of Examples 31 and 32, and wherein sending the location request comprises sending a location request that includes an identifier indicative of the target, wherein the target comprises a target mobile computing device.

Example 34 includes the subject matter of any of Examples 31-33, and wherein: sending the location request comprises sending a secure user plane location protocol message that includes a parameter indicative of the request for directions; and receiving the response comprises receiving a secure user plane location protocol message that includes a parameter indicative of the route from the mobile computing device to the target.

Example 35 includes the subject matter of any of Examples 31-34, and wherein: sending the location request comprises sending a secure user plane location protocol SUPL SET INIT message, wherein the SUPL SET INIT message includes the parameter indicative of the request for directions; and receiving the response comprises receiving a secure user plane location protocol SUPL END message, wherein the SUPL END message includes the parameter indicative of the route from the mobile computing device to the target.

Example 36 includes the subject matter of any of Examples 31-35, and further comprising discovering, by the mobile computing device, the location server, wherein establishing the secure data connection with the location server comprises establishing the secure data connection in response to discovering the location server.

Example 37 includes the subject matter of any of Examples 31-36, and wherein establishing the secure data connection with the location server comprises establishing the secure data connection in response to discovering the location server via an unsecure network discovery protocol.

Example 38 includes the subject matter of any of Examples 31-37, and wherein receiving the response from the location server comprises receiving a response that includes geographic coordinates of the target.

Example 39 includes the subject matter of any of Examples 31-38, and wherein receiving the response from the location server comprises receiving a response that includes turn-by-turn directions to the target.

Example 40 includes the subject matter of any of Examples 31-39, and wherein receiving the response from the location server comprises receiving a response that includes directions to the target relative to a landmark.

Example 41 includes the subject matter of any of Examples 31-40, and wherein receiving the response from the location server comprises receiving a response that includes an image indicative of the route from the mobile computing device to the target.

Example 42 includes the subject matter of any of Examples 31-41, and wherein: sending the location request to the location server via the secure data connection comprises sending a location request that includes a trigger parameter for periodic positioning; and receiving the response from the location server in response to sending the location request comprises periodically receiving a response from the location server in response to sending the location request.

Example 43 includes the subject matter of any of Examples 31-42, and further comprising receiving, by the mobile computing device, a message to stop periodic positioning from the location server in response to sending the location request, wherein the message is indicative of a final route from the mobile computing device to the target.

Example 44 includes the subject matter of any of Examples 31-43, and wherein: sending the location request comprises sending a secure user plane location protocol SUPL SET INIT message, wherein the SUPL SET INIT message includes a parameter indicative of the request for directions; and periodically receiving the response comprises periodically receiving a secure user plane location protocol SUPL REPORT message, wherein the SUPL REPORT message includes a parameter indicative of the route from the mobile computing device to the target.

Example 45 includes a method for guided navigation, the method comprising: establishing, by a computing device, a secure data connection with a requestor mobile computing device; receiving, by the computing device, a location request from the requestor mobile computing device via the secure data connection, wherein the location request includes an identifier of a target and a request for directions; determining, by the computing device, a route from the requestor mobile computing device to the target based on a position of the target; and sending, by the computing device, a response to the requestor mobile computing device, wherein the response is indicative of the route from the requestor mobile computing device to the target.

Example 46 includes the subject matter of Example 45, and wherein receiving the location request comprises receiving a location request that includes an identifier indicative of the target, wherein the target comprises a target geographic location.

Example 47 includes the subject matter of any of Examples 45 and 46, and wherein receiving the location request comprises receiving a location request that includes an identifier indicative of the target, wherein the target comprises a target mobile computing device.

Example 48 includes the subject matter of any of Examples 45-47, and further comprising performing, by the computing device in response to receiving the location request, a positioning procedure with the target mobile computing device to determine the position of the target mobile computing device;

Example 49 includes the subject matter of any of Examples 45-48, and wherein performing the positioning procedure with the target mobile computing device comprises performing a device-assisted positioning procedure with the target mobile computing device.

Example 50 includes the subject matter of any of Examples 45-49, and wherein performing the positioning procedure with the target mobile computing device comprises performing a device-based positioning procedure with the target mobile computing device.

Example 51 includes the subject matter of any of Examples 45-50, and wherein performing the positioning procedure comprises performing the positioning procedure with a local positioning system.

Example 52 includes the subject matter of any of Examples 45-51, and wherein: receiving the location request comprises receiving a secure user plane location protocol message that includes a parameter indicative of the request for directions; and sending the response comprises sending a secure user plane location protocol message that includes a parameter indicative of the route from the mobile computing device to the target.

Example 53 includes the subject matter of any of Examples 45-52, and wherein: receiving the location request comprises receiving a secure user plane location protocol SUPL SET INIT message, wherein the SUPL SET INIT message includes the parameter indicative of the request for directions; and sending the response comprises sending a secure user plane location protocol SUPL END message, wherein the SUPL END message includes the parameter indicative of the route from the mobile computing device to the target.

Example 54 includes the subject matter of any of Examples 45-53, and wherein sending the response to the requestor mobile computing device comprises sending a response that includes geographic coordinates of the target.

Example 55 includes the subject matter of any of Examples 45-54, and wherein sending the response to the requestor mobile computing device comprises sending a response that includes turn-by-turn directions to the target.

Example 56 includes the subject matter of any of Examples 45-55, and wherein sending the response to the requestor mobile computing device comprises sending a response that includes directions to the target relative to a landmark.

Example 57 includes the subject matter of any of Examples 45-56, and wherein: determining the route from the requestor mobile computing device to the target comprises generating an image indicative of the route from the mobile computing device to the target; and sending the response to the requestor mobile computing device comprises sending a response that includes the image.

Example 58 includes the subject matter of any of Examples 45-57, and wherein: receiving the location request from the requestor mobile computing device via the secure data connection comprises receiving a location request that includes a trigger parameter for periodic positioning; and sending the response to the requestor mobile computing device comprises periodically sending a response to the requestor mobile computing device in response to receiving the location request.

Example 59 includes the subject matter of any of Examples 45-58, and further comprising sending, by the computing device, a message to stop periodic positioning to the requestor mobile computing device in response to receiving the location request, wherein the message is indicative of a final route from the requestor mobile computing device to the target.

Example 60 includes the subject matter of any of Examples 45-59, and wherein: receiving the location request comprises receiving a secure user plane location protocol SUPL SET INIT message, wherein the SUPL SET INIT message includes a parameter indicative of the request for directions; and periodically sending the response comprises periodically sending a secure user plane location protocol SUPL REPORT message, wherein the SUPL REPORT message includes a parameter indicative of the route from the requestor mobile computing device to the target.

Example 61 includes a computing device comprising: a processor; and a memory having stored therein a plurality of instructions that when executed by the processor cause the computing device to perform the method of any of Examples 31-60.

Example 62 includes one or more machine readable storage media comprising a plurality of instructions stored thereon that in response to being executed result in a computing device performing the method of any of Examples 31-60.

Example 63 includes a computing device comprising means for performing the method of any of Examples 31-60.

Example 64 includes a mobile computing device for guided navigation, the mobile computing device comprising: means for establishing a secure data connection with a location server; means for sending a location request to the location server via the secure data connection, wherein the location request includes an identifier of a target and a request for directions; and means for receiving a response from the location server in response to sending the location request, wherein the response is indicative of a route from the mobile computing device to the target.

Example 65 includes the subject matter of Example 64, and wherein the means for sending the location request comprises means for sending a location request that includes an identifier indicative of the target, wherein the target comprises a target geographic location.

Example 66 includes the subject matter of any of Examples 64 and 65, and wherein the means for sending the location request comprises means for sending a location request that includes an identifier indicative of the target, wherein the target comprises a target mobile computing device.

Example 67 includes the subject matter of any of Examples 64-66, and wherein: the means for sending the location request comprises means for sending a secure user plane location protocol message that includes a parameter indicative of the request for directions; and the means for receiving the response comprises means for receiving a secure user plane location protocol message that includes a parameter indicative of the route from the mobile computing device to the target.

Example 68 includes the subject matter of any of Examples 64-67, and wherein: the means for sending the location request comprises means for sending a secure user plane location protocol SUPL SET INIT message, wherein the SUPL SET INIT message includes the parameter indicative of the request for directions; and the means for receiving the response comprises means for receiving a secure user plane location protocol SUPL END message, wherein the SUPL END message includes the parameter indicative of the route from the mobile computing device to the target.

Example 69 includes the subject matter of any of Examples 64-68, and further comprising means for discovering the location server, wherein the means for establishing the secure data connection with the location server comprises means for establishing the secure data connection in response to discovering the location server.

Example 70 includes the subject matter of any of Examples 64-69, and wherein the means for establishing the secure data connection with the location server comprises means for establishing the secure data connection in response to discovering the location server via an unsecure network discovery protocol.

Example 71 includes the subject matter of any of Examples 64-70, and wherein the means for receiving the response from the location server comprises means for receiving a response that includes geographic coordinates of the target.

Example 72 includes the subject matter of any of Examples 64-71, and wherein the means for receiving the response from the location server comprises means for receiving a response that includes turn-by-turn directions to the target.

Example 73 includes the subject matter of any of Examples 64-72, and wherein the means for receiving the response from the location server comprises means for receiving a response that includes directions to the target relative to a landmark.

Example 74 includes the subject matter of any of Examples 64-73, and wherein the means for receiving the response from the location server comprises means for receiving a response that includes an image indicative of the route from the mobile computing device to the target.

Example 75 includes the subject matter of any of Examples 64-74, and wherein: the means for sending the location request to the location server via the secure data connection comprises means for sending a location request that includes a trigger parameter for periodic positioning; and the means for receiving the response from the location server in response to sending the location request comprises means for periodically receiving a response from the location server in response to sending the location request.

Example 76 includes the subject matter of any of Examples 64-75, and further comprising means for receiving a message to stop periodic positioning from the location server in response to sending the location request, wherein the message is indicative of a final route from the mobile computing device to the target.

Example 77 includes the subject matter of any of Examples 64-76, and wherein: the means for sending the location request comprises means for sending a secure user plane location protocol SUPL SET INIT message, wherein the SUPL SET INIT message includes a parameter indicative of the request for directions; and the means for periodically receiving the response comprises means for periodically receiving a secure user plane location protocol SUPL REPORT message, wherein the SUPL REPORT message includes a parameter indicative of the route from the mobile computing device to the target.

Example 78 includes a computing device for guided navigation, the computing device comprising: means for establishing a secure data connection with a requestor mobile computing device; means for receiving a location request from the requestor mobile computing device via the secure data connection, wherein the location request includes an identifier of a target and a request for directions; means for determining a route from the requestor mobile computing device to the target based on a position of the target; and means for sending a response to the requestor mobile computing device, wherein the response is indicative of the route from the requestor mobile computing device to the target.

Example 79 includes the subject matter of Example 78, and wherein the means for receiving the location request comprises means for receiving a location request that includes an identifier indicative of the target, wherein the target comprises a target geographic location.

Example 80 includes the subject matter of any of Examples 78 and 79, and wherein the means for receiving the location request comprises means for receiving a location request that includes an identifier indicative of the target, wherein the target comprises a target mobile computing device.

Example 81 includes the subject matter of any of Examples 78-80, and further comprising means for performing, in response to receiving the location request, a positioning procedure with the target mobile computing device to determine the position of the target mobile computing device;

Example 82 includes the subject matter of any of Examples 78-81, and wherein the means for performing the positioning procedure with the target mobile computing device comprises means for performing a device-assisted positioning procedure with the target mobile computing device.

Example 83 includes the subject matter of any of Examples 78-82, and wherein the means for performing the positioning procedure with the target mobile computing device comprises means for performing a device-based positioning procedure with the target mobile computing device.

Example 84 includes the subject matter of any of Examples 78-83, and wherein the means for performing the positioning procedure comprises means for performing the positioning procedure with a local positioning system.

Example 85 includes the subject matter of any of Examples 78-84, and wherein: the means for receiving the location request comprises means for receiving a secure user plane location protocol message that includes a parameter indicative of the request for directions; and the means for sending the response comprises means for sending a secure user plane location protocol message that includes a parameter indicative of the route from the mobile computing device to the target.

Example 86 includes the subject matter of any of Examples 78-85, and wherein: the means for receiving the location request comprises means for receiving a secure user plane location protocol SUPL SET INIT message, wherein the SUPL SET INIT message includes the parameter indicative of the request for directions; and the means for sending the response comprises means for sending a secure user plane location protocol SUPL END message, wherein the SUPL END message includes the parameter indicative of the route from the mobile computing device to the target.

Example 87 includes the subject matter of any of Examples 78-86, and wherein the means for sending the response to the requestor mobile computing device comprises means for sending a response that includes geographic coordinates of the target.

Example 88 includes the subject matter of any of Examples 78-87, and wherein the means for sending the response to the requestor mobile computing device comprises means for sending a response that includes turn-by-turn directions to the target.

Example 89 includes the subject matter of any of Examples 78-88, and wherein the means for sending the response to the requestor mobile computing device comprises means for sending a response that includes directions to the target relative to a landmark.

Example 90 includes the subject matter of any of Examples 78-89, and wherein: the means for determining the route from the requestor mobile computing device to the target comprises means for generating an image indicative of the route from the mobile computing device to the target; and the means for sending the response to the requestor mobile computing device comprises means for sending a response that includes the image.

Example 91 includes the subject matter of any of Examples 78-90, and wherein: the means for receiving the location request from the requestor mobile computing device via the secure data connection comprises means for receiving a location request that includes a trigger parameter for periodic positioning; and the means for sending the response to the requestor mobile computing device comprises means for periodically sending a response to the requestor mobile computing device in response to receiving the location request.

Example 92 includes the subject matter of any of Examples 78-91, and further comprising means for sending a message to stop periodic positioning to the requestor mobile computing device in response to receiving the location request, wherein the message is indicative of a final route from the requestor mobile computing device to the target.

Example 93 includes the subject matter of any of Examples 78-92, and wherein: the means for receiving the location request comprises means for receiving a secure user plane location protocol SUPL SET INIT message, wherein the SUPL SET INIT message includes a parameter indicative of the request for directions; and the means for periodically sending the response comprises means for periodically sending a secure user plane location protocol SUPL REPORT message, wherein the SUPL REPORT message includes a parameter indicative of the route from the requestor mobile computing device to the target.

1. A mobile computing device for guided navigation, the mobile computing device comprising:
a secure connection module to establish a secure data connection with a location server;
a request module to send a location request to the location server via the secure data connection, wherein the location request includes an identifier of a target and a request for directions; and
a response module to receive a response from the location server in response to sending of the location request, wherein the response is indicative of a route from the mobile computing device to the target.

2. The mobile computing device of claim 1, wherein:
the location request comprises a secure user plane location protocol SUPL SET INIT message, wherein the SUPL SET INIT message includes a parameter indicative of the request for directions; and
the response comprises a secure user plane location protocol SUPL END message, wherein the SUPL END message includes a parameter indicative of the route from the mobile computing device to the target.

3. The mobile computing device of claim 1, further comprising a server discovery module to discover the location server; wherein to establish the secure data connection with the location server comprises to establish the secure data connection in response to discovery of the location server.

4. The mobile computing device of claim 1, wherein the response includes an image indicative of the route from the mobile computing device to the target.

5. The mobile computing device of claim 1, wherein:
the location request includes a trigger parameter for periodic positioning; and
to receive the response from the location server in response to the sending of the location request comprises to periodically receive a response from the location server in response to the sending of the location request.

6. The mobile computing device of claim 5, wherein:
the location request comprises a secure user plane location protocol SUPL SET INIT message, wherein the SUPL SET INIT message includes a parameter indicative of the request for directions; and
the response comprises a secure user plane location protocol SUPL REPORT message, wherein the SUPL REPORT message includes a parameter indicative of the route from the mobile computing device to the target.

7. One or more computer-readable storage media comprising a plurality of instructions that in response to being executed cause a mobile computing device to:
establish a secure data connection with a location server;
send a location request to the location server via the secure data connection, wherein the location request includes an identifier of a target and a request for directions; and
receive a response from the location server in response to sending the location request, wherein the response is indicative of a route from the mobile computing device to the target.

8. The one or more computer-readable storage media of claim 7, further comprising a plurality of instructions that in response to being executed cause the mobile computing device to discover the location server, wherein to establish the secure data connection with the location server comprises to establish the secure data connection in response to discovering the location server.

9. The one or more computer-readable storage media of claim 7, wherein to receive the response from the location server comprises to receive a response that includes an image indicative of the route from the mobile computing device to the target.

10. The one or more computer-readable storage media of claim 7, wherein:
to send the location request to the location server via the secure data connection comprises to send a location request that includes a trigger parameter for periodic positioning; and
to receive the response from the location server in response to sending the location request comprises to periodically receive a response from the location server in response to sending the location request.

11. A computing device for guided navigation, the computing device comprising:
a secure connection module to establish a secure data connection with a requestor mobile computing device;
a request module to receive a location request from the requestor mobile computing device via the secure data connection, wherein the location request includes an identifier of a target and a request for directions;
a positioning module to determine a route from the requestor mobile computing device to the target based on a position of the target; and
a response module to send a response to the requestor mobile computing device, wherein the response is indicative of the route from the requestor mobile computing device to the target.

12. The computing device of claim 11, wherein the location request includes an identifier indicative of the target, wherein the target comprises a target geographic location.

13. The computing device of claim 11, wherein the location request includes an identifier indicative of the target, wherein the target comprises a target mobile computing device.

14. The computing device of claim 13, wherein the positioning module is further to perform, in response to receipt of the location request, a positioning procedure with the target mobile computing device to determine the position of the target mobile computing device.

15. The computing device of claim 14, wherein to perform the positioning procedure comprises to perform the positioning procedure with a local positioning system.

16. The computing device of claim 11, wherein:
the location request comprises a secure user plane location protocol SUPL SET INIT message, wherein the SUPL SET INIT message includes a parameter indicative of the request for directions; and
the response comprises a secure user plane location protocol SUPL END message, wherein the SUPL END message includes a parameter indicative of the route from the mobile computing device to the target.

17. The computing device of claim 11, wherein:
to determine the route from the requestor mobile computing device to the target comprises to generate an image indicative of the route from the mobile computing device to the target; and
to send the response to the requestor mobile computing device comprises to send a response that includes the image.

18. The computing device of claim 11, wherein:
the location request includes a trigger parameter for periodic positioning; and
to send the response to the requestor mobile computing device comprises to periodically send a response to the requestor mobile computing device in response to receipt of the location request.

19. The computing device of claim 18, wherein:
the location request comprises a secure user plane location protocol SUPL SET INIT message, wherein the SUPL SET INIT message includes a parameter indicative of the request for directions; and
the response comprises a secure user plane location protocol SUPL REPORT message, wherein the SUPL REPORT message includes a parameter indicative of the route from the requestor mobile computing device to the target.

20. One or more computer-readable storage media comprising a plurality of instructions that in response to being executed cause a computing device to:
establish a secure data connection with a requestor mobile computing device;
receive a location request from the requestor mobile computing device via the secure data connection, wherein the location request includes an identifier of a target and a request for directions;
determine a route from the requestor mobile computing device to the target based on a position of the target; and
send a response to the requestor mobile computing device, wherein the response is indicative of the route from the requestor mobile computing device to the target.

21. The one or more computer-readable storage media of claim 20, wherein to receive the location request comprises to receive a location request that includes an identifier indicative of the target, wherein the target comprises a target mobile computing device.

22. The one or more computer-readable storage media of claim 21, further comprising a plurality of instructions that in response to being executed cause the computing device to perform, in response to receiving the location request, a positioning procedure with the target mobile computing device to determine the position of the target mobile computing device.

23. The one or more computer-readable storage media of claim 22, wherein to perform the positioning procedure comprises to perform the positioning procedure with a local positioning system.

24. The one or more computer-readable storage media of claim 20, wherein:
to determine the route from the requestor mobile computing device to the target comprises to generate an image indicative of the route from the mobile computing device to the target; and
to send the response to the requestor mobile computing device comprises to send a response that includes the image.

25. The one or more computer-readable storage media of claim 20, wherein:
to receive the location request from the requestor mobile computing device via the secure data connection comprises to receive a location request that includes a trigger parameter for periodic positioning; and
to send the response to the requestor mobile computing device comprises to periodically send a response to the requestor mobile computing device in response to receiving the location request.
